(19) United States
(12) Patent Application Publication
(10) Pub. No.: US 2025/0041145 A1
(43) Pub. Date: Feb. 6, 2025

(54) APPARATUS FOR SEATED SPINAL DECOMPRESSION

(71) Applicant: Vahabi, Ltd., Chicago, IL (US)

(72) Inventor: Soheila Vahabi, Chicago, IL (US)

(21) Appl. No.: 18/604,059

(22) Filed: Mar. 13, 2024

Related U.S. Application Data
(60) Provisional application No. 63/517,323, filed on Aug. 2, 2023.

(51) Int. Cl. A61H 1/02

(52) U.S. Cl. CPC A61H 1/0218

(57) ABSTRACT

A therapeutic chair and a physical therapy device are provided, each of which includes a back support, a seat pan, and a tilting mechanism coupled to the seat pan. The tilting mechanism is configured to select and/or allow a user to select, from a standard position and a plurality of declined positions, a selected seat pan position. Each of the plurality of declined positions corresponds to an angle of declination of the seat pan. Each respective declined position of the plurality of declined positions is configured to promote spinal decompression of a respective target region of a spine of an occupant. Spinal decompression treatment, which can alleviate pain and prevent costly surgical interventions, can thereby be provided in a natural, vertical position of the human spine and in a common, convenient position (i.e. a seated position) for an occupant/patient.

### CROSS REFERENCE TO RELATED APPLICATIONS

This application claims benefit to U.S. Provisional Patent Application No. 63/517,323, filed on Aug. 2, 2023, which is hereby incorporated by reference herein.

### FIELD

The present disclosure is directed to spinal decompression and, more specifically, to devices for decompressing a human spine from a seated position.

### BACKGROUND

The human spine (or backbone) provides support for the body and includes bones called vertebrae, which, together with ligaments and spinal discs, make up the vertebral column. A nerve pathway runs through the middle of these bones, ligaments and discs, providing a canal through which the spinal cord extends.

FIG. 1 provides an anterior, a left lateral, and a posterior view of a human spine. The human spine is broken up into three major regions. Each region possesses unique attributes in terms of rotation and motion. The top seven vertebrae of the spine are called the cervical vertebrae (C1-C7). Vertebrae are individual bones that make up the vertebra column. With the exception of the first and second cervical vertebrae (C1-C2), all individual vertebra are movable. The remaining cervical vertebrae (C3-C7) are among the most expressive, able to undergo the greatest amount of movement and rotation.

The middle region of the spine is the thoracic region (T1-T12). The thoracic vertebrae connect the ribs and part of the back wall of the thorax. The thoracic vertebrae are also relatively expressive, but are not able to undergo the same degree of movement and rotation as the movable cervical vertebrae (i.e. C3-C7). The thoracic region of the spine contains a large arch that allows humans to bear loads (e.g., carry objects). Kyphosis is the natural curve of the thoracic spine, which is usually found to be between 20 to 40 degrees. Curvature greater than 40-50 degrees may be caused by disease or other deformity.

The lumbar region of the spine includes the lumbar vertebrae (L1-L5), which offer the greatest load bearing capabilities of any vertebrae. While the lumbar vertebrae also have the ability to flex, they are the least moveable vertebrae in terms of both lateral and vertical rotation. They are also much larger than the other vertebra due to their need to bear the load of the rest of the spine. Beneath the lumbar region lie the sacrum and the coccyx. At birth, humans have 5 individual sacral vertebrae and additional coccygeal bones that, during growth and development, fuse to form the sacrum and the coccyx.

Intervertebral discs lie between the individual vertebrae in the spine and act as the connectivity medium between individual vertebrae. The discs are a jelly like tissue that stretch and compress according to the rotation and movement of the spine. The size of the discs increases from top to bottom of the spine, and the lumbar region contains some of the largest discs. The intervertebral discs act as mediums to keep the spine in track. A small amount of compression and extension in the vertical direction is provided as a by-product of these discs.

Humans are born with a single curve in their spine (i.e. the thoracic curvature—see FIG. 1). During growth, muscle structures are created that cause load bearing weight on the spine, thereby causing the lumber curve to form (see FIG. 1). Shortly thereafter, the load caused by balancing the head causes the cervical curve to form (see FIG. 1). Eventually these curves stabilize, resulting in the spinal curvature found in all normal adults. A normal spine contains an “S”-like curve if viewed form the side.

Spine injuries or degeneration to the spine can cause pain. Often times, the pain is felt from compression in the spine that puts pressure on the spinal cord and/or nerves. Spinal decompression treatment seeks to relieve the pressure to case the pain and is particularly suited to treat ailments including, but not limited to, bulging discs (when a cushion between vertebrae bulges out), degenerative discs (when the cushion between vertebrae starts wearing out), herniated discs, (when part of a disc pushes on a nerve), pinched nerves (when a nerve gets pinched or compressed, causing numbness, pain or tingling), sciatica (damage to the sciatic nerve), and spinal stenosis (narrowing of spaces in the spine due to bone spurs or bulging or herniated discs).

Some of the treatments include techniques like acupuncture, manual spinal adjustment by a chiropractor, physical therapy (exercise, manual stretching) and nerve stimulation (e.g., transcutaneous electrical nerve stimulation). In addition, devices such as traction tables and inversion tables can be used, where pulleys and weights are used to stretch the spine. Inversion therapy is also used to utilize traction from gravity, where the angle of the body lying on an inversion table is tilted, relieving pressure on the spine.

### SUMMARY

In an embodiment, the present disclosure provides a therapeutic chair. The therapeutic chair includes a back support, a seat pan, and a tilting mechanism coupled to the seat pan. The tilting mechanism is configured to select, from a standard position and a plurality of declined positions, a selected seat pan position. Each of the plurality of declined positions corresponds to an angle of declination of the seat pan. Each respective declined position of the plurality of declined positions is configured to promote spinal decompression of a respective target region of a spine of an occupant.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an example of a human spine;

FIGS. 2A through 2F illustrate different views and configurations of a reverse-tilt chair comprising a seat, back support, and seat pan tilting mechanism according to an embodiment;

FIGS. 3A through 3C illustrate different views of a back support, and portions thereof, of the reverse-tilt chair depicted in FIGS. 2A through 2F;

FIGS. 4A through 4C illustrate configurations of the combination of a base and a seat combination of the reverse-tilt chair depicted in FIGS. 2A through 2F;

FIG. 4D illustrates a variant of a seat pan, suitable as a component of the reverse-tilt chair depicted in FIGS. 2A through 2F, according to an embodiment;

FIGS. 5A through 5C illustrate configurations of an armrest and armrest tilting mechanism of the reverse-tilt chair depicted in FIGS. 2A through 2F;

FIGS. 6A and 6B illustrate different configurations of a reverse-tilt chair comprising a seat, back support, and alternative seat pan tilting mechanism according to a further embodiment;

FIGS. 6C through 6E illustrate, in detailed views, the alternative seat pan tilting mechanism, and components thereof, of the reverse-tilt chair depicted in FIGS. 6A and 6B;

FIG. 7 illustrates a further alternative seat pan tilting mechanism according to a further embodiment;

FIGS. 8A and 8B illustrate configurations of an armrest and alternative armrest tilting mechanism according to an embodiment;

FIG. 9 illustrates a reverse-tilt chair comprising a seat, back support, and seat pan tilting mechanism according to a further embodiment;

FIGS. 10A and 10B illustrate alternative views and configurations of a clinical rehabilitation/physical therapy device according to an embodiment;

FIG. 10C illustrates an example of arm pulley movements of arm-pulleys of the clinical rehabilitation/physical therapy device illustrated in FIGS. 10A and 10B; and

FIG. 10D illustrates declination of a seat pan of the of the clinical rehabilitation/physical therapy device illustrated in FIGS. 10A and 10B.

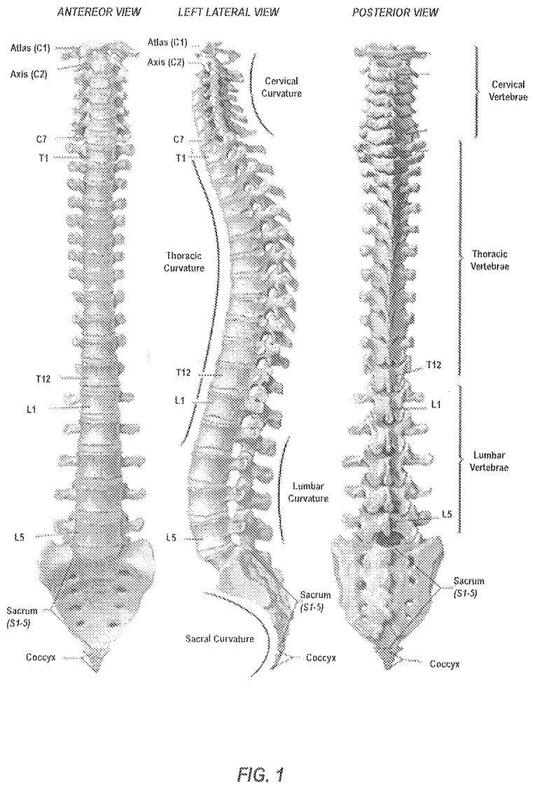

### DETAILED DESCRIPTION

The human body was never meant to sit for 8 to 10 hours per day, and long hours of sitting and/or driving in ill-designed office chairs and car seats can lead to a variety of health problems. Prolonged sitting and a lack of activity endemic to our modern environment—combined with the constant action of gravity on the human body—promotes, over time, spinal compression, which is a primary root cause of many spine related problems. Spinal compression and spinal segmental immobility results in the loss of proper spinal curvature, often creating a forward posture. Initially, the lumbar spine suffers the most and proper lumbar spine curvature is the first victim (lordosis). Eventually, the loss of proper lumbar spine curvature will have a domino effect, and proper curvature of the remainder of the spine—including proper neck curvature—can be lost. As a result, a forward head posture can develop, which can, in turn, cause neck pain, headaches, dizziness, and balance issues.

Conventional spinal decompression treatments typically employ specialized equipment that is designed to be operated by a health care professional, e.g. a chiropractor, in a clinical setting. Such equipment includes, e.g., traction tables and inversion tables. However, both traction tables and inversion tables have a number of drawbacks. For example, inversion tables do not directly decompress the spine of a patient. Instead, inversion tables provide indirect decompression by relaxing the soft tissues and promoting mobilization of cerebral spinal fluid (CSF) in the direction of the patient's head. Furthermore, inversion tables can be unsafe for a variety of reasons. In an inverted position, movement of CSF toward the patient's head and build up excess pressure in the cranium, which can result, for example, in headaches, visual disturbances, and dizziness. In addition, a risk of serious injury and even paralysis is associated with the use of an inversion table, as failure to properly secure a patient (e.g. by the ankles) can result in the patient falling, from an upside down position, and crashing into the floor with direct impact to the head and/or cervical spine. The use of traction tables also entails certain drawbacks. Conventional traction tables require a clinician to set up and perform the decompression. Furthermore, conventional traction tables do not apply decompression treatments to a patient's spine in its natural, vertical position with actual weight loading, barring pressure on the spine. Prior to the development of the devices and techniques described herein, effective spinal decompression treatments suitable for application to a patient in a seated position were not available.

The present disclosure provides devices and techniques for decompressing a human spine from a seated position. The devices and techniques provided by the present disclosure provide direct decompression of the spine and in a manner that can target specific regions of the spine. Specifically, the present disclosure provides, according to various aspects, a spinal decompression chair (e.g. in the form of an office chair), a physical therapy device configured to provide spinal decompression treatment of a patient situated in a seated position, and a technique for providing spinal decompression treatment to a patient in a seated position. The devices and techniques of the present disclosure thereby provide spinal decompression treatment in a natural, vertical position of the human spine and in a common, convenient position (i.e. a seated position) for an occupant/patient. Furthermore, by providing a chair that is configured to provide spinal decompression treatment, the present disclosure facilitates spinal decompression treatments in convenient, non-clinical settings, e.g. an office environment. The present disclosure thereby facilitates frequent application of spinal decompression, thus promoting preventative measures to combat spinal ailments, such as degenerative joint disease (DJD) —more commonly known as arthritis, bulging discs, regular wear and tear in the spine cause by daily activity, and sciatic nerve pain.

The devices and techniques of the present disclosure, which provide for spinal decompression treatment in a natural, vertical position of the human spine, can be used in daily life or in a rehabilitation facility setting. The devices and techniques of the present disclosure can remedy the above mentioned health problems that result from spinal compression and revolutionize the approach to treatment of endemic lower back pain and the overall spine pain and dysfunction promoted by modern lifestyles.

According to a first aspect, the present disclosure provides a chair (e.g. an office chair) configured to facilitate spinal decompression treatment of an occupant situated in a seated position. By facilitating spinal decompression, the chair according to the first aspect can release pressure on nerves that are compressed in the intervertebral foramina (i.e. the openings in which peripheral nerves exit from the spinal cord in order to innervate different regions of the body). Regular daily use of the spinal decompression chair of the present disclosure can alleviate pain and prevent further degeneration of a patient's condition, thereby decreasing the risk of injury. Use of the spinal decompression chair of the present disclosure can also decrease the time required for treatment of back pain and the time required for recovery from injury. In addition, use of the spinal decompression chair of the present disclosure can obviate the need for treating injury via more expensive and invasive procedures, such as surgery.

Conventional chair designs utilize any of a number of tilting mechanisms for reclining a chair. However, each of these tilting designs has drawbacks, particularly from the perspective of spinal compression. One tilting design includes center tilt mechanisms, also known as “swivel-tilt” or “single-point tilt” mechanisms, which locate the pivot point of a chair directly underneath the center of the chair. With conventional center tilt mechanisms, the back support backward tilt (i.e., the angle between the seat and the back support) remains constant as the chair reclines. Not only does this design promote spinal compression in the seated position, it also leads to a rise of the seat's front lip concurrently with the reclining of the back support, resulting in the feet rising off the ground and creating pressure on the underside of the legs, potentially decreasing the circulation of blood thereto. Another tilting design includes knee tilt mechanisms, in which the pivot point of the chair is moved from the center of the chair centerline to an area just behind the knees. While this design removes some of the drawbacks of a center tilt mechanism, the bulk of the weight stays behind the pivot point, often resulting in further compression on portions of the spine. Multifunction mechanisms, also known as asynchronous mechanisms, function in a similar manner to center-tilt mechanisms, but provide the option of locking the tilt in any position by using a seat angle lock mechanism. Multifunction mechanisms suffer from the same drawbacks as center tilt mechanisms, discussed above, and also promote spinal compression, rather than decompression, in the seated position.

In contrast to conventional chair tilt designs, the chair according to the first aspect of the present disclosure is configured to promote decompression of the occupant's spine. The chair according to the first aspect includes an adjustable seat pan and a back support. The adjustable seat pan is configured to undergo a reverse-tilt, or declination, adjustment, whereby the seat pan is made to slope in a downward direction from a front portion of the seat pan to a rear portion of the seat pan (i.e. to slope downwards in a direction extending from the knees to the hips of the occupant). In this manner, the chair according to the first aspect of the present disclosure is configured to supply spinal traction to the occupant, thereby promoting decompression of the occupant's spine.

In various embodiments, the chair according to the first aspect is configured such that the declination adjustment of the seat pan is able to be carried out independently of any adjustment of the back support. To provide for the independent movement of the seat pan, the seat pan and the back support are independently supported and independently connected to a base of the chair. Independent support of the seat pan and the back support is achieved, according to various embodiments, by providing a first support structure that connects the seat pan to the base of the chair and further providing a second support structure that independently connects the back support to the base of the chair. The first support structure can be, according to various embodiments, a support column that is connected to and/or includes a tilting mechanism configured to effectuate the reverse-tilt adjustment of the seat pan.

According to a second aspect, the present disclosure provides a clinical medical rehabilitation/physical therapy device configured to facilitate spinal decompression treatment of a patient situated in a seated position. By facilitating spinal decompression, the clinical medical rehabilitation/physical therapy device according to the second aspect can, like the chair according to the first aspect, release pressure on nerves that are compressed in the intervertebral foramina (i.e. the openings in which peripheral nerves exit from the spinal cord in order to innervate different regions of the body). Consistent use, e.g. at regular treatment sessions in a clinical setting, of the clinical medical rehabilitation/physical therapy device of the present disclosure can both treat injury and serve as a preventative intervention limiting the risk that more expensive and invasive treatments, such as surgery, would become necessary.

According to an embodiment of the first aspect, a therapeutic chair is provided, having a back support, a seat pan, and a seat pan tilting mechanism coupled to the seat pan. The seat pan tilting mechanism is configured to decline the seat pan from a standard position to a selected declined seat pan position, the selected declined seat position being selected from one of a plurality of declined positions. Each of the plurality of declined positions corresponds to an angle of declination of the seat pan. The seat pan tilting mechanism is configured to decline the seat pan to the selected declined seat pan position independent from a reclining motion of the back support.

In variations, the therapeutic chair includes a base, and the back support is connected to the base via a first structure and the seat pan is connected to the base via a second structure independent from the first structure. The seat pan tilting mechanism can be configured as a component of the second structure. The seat pan tilting mechanism can include a pivot joint and a depressible piston. The seat pan tilting mechanism can be configured to lower a rear portion of the seat pan relative to a front portion of the seat pan, the rear portion of the seat pan disposed proximal to the back support and the front portion of the seat pan disposed distal from the back support. The standard position can correspond to a minimum declination of the seat pan, and the maximum declination of the seat pan can be an angle in a range of 45° to 60°, wherein the angle is measured between a first direction extending from a rear of the seat pan to a front of the seat pan and a horizontal direction that extends parallel to a floor on which the chair is configured to sit.

In variations of the therapeutic chair according to the embodiment of the first aspect, the plurality of declined positions are configured such that each respective declined position targets a respective target region of a spine of the occupant for decompression. The respective target region of the human spine can be, e.g. a lumbar region, a thoracic region, a cervical region, or a combination thereof. Each respective declined position can be further configured to target one or more respective vertebrae for spinal decompression.

According to an embodiment of the second aspect, a physical therapy device, configured to facilitate spinal decompression treatment of a patient situated in a seated position, is provided. The physical therapy device includes a seat pan and a tilting mechanism coupled to the seat pan. The tilting mechanism is configured to decline the seat pan from a standard position to a selected declined seat pan position, the selected declined seat position being selected from one of a plurality of declined positions. Each of the plurality of declined positions corresponds to an angle of declination of the seat pan. The physical therapy device further includes a back support and cervical traction supports. The seat pan tilting mechanism is configured to decline the seat pan to the selected declined seat pan position independent from a reclining motion of the back support.

In variations, the plurality of declined positions are configured such that each respective declined position targets a respective target region of a spine of the occupant for decompression. The physical therapy device according to the embodiment of the second aspect can also include a retractable traction assembly, and the back support and the cervical traction supports can be mounted on the retractable traction assembly and configured to move along the retractable traction assembly. The physical therapy device can also include two arm-pulleys positioned on either lateral side of the seat pan, wherein the arm-pulleys are configured to be pulled by the occupant to enhance spinal traction mobilization. A non-retracted length of the arm-pulleys can be determined based on the selected seat pan position.

Various embodiments will be described herein below with reference to the accompanying drawings.

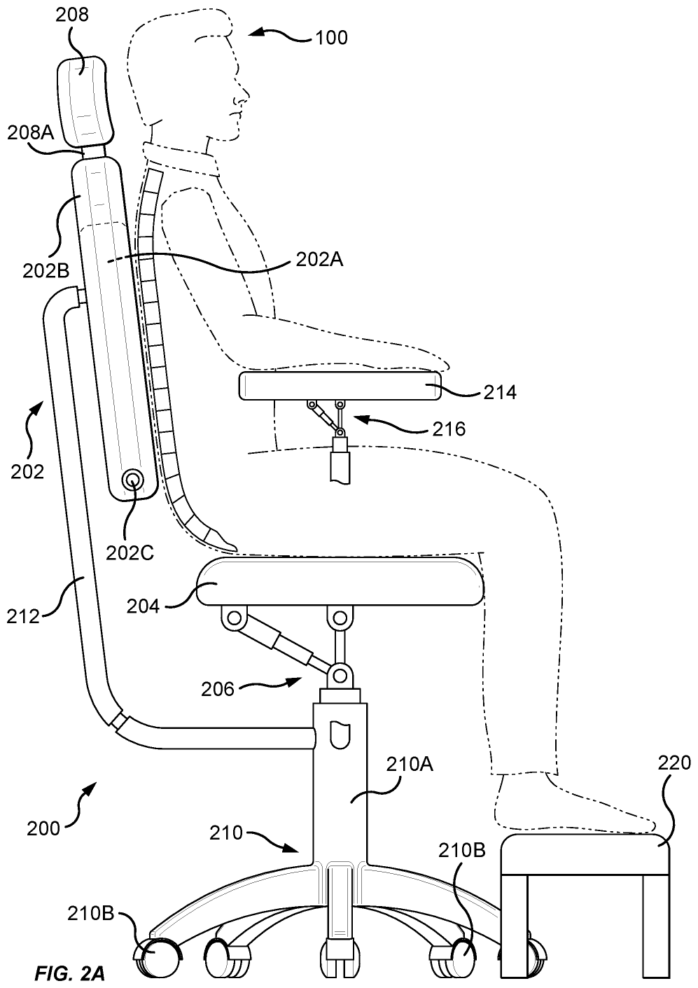

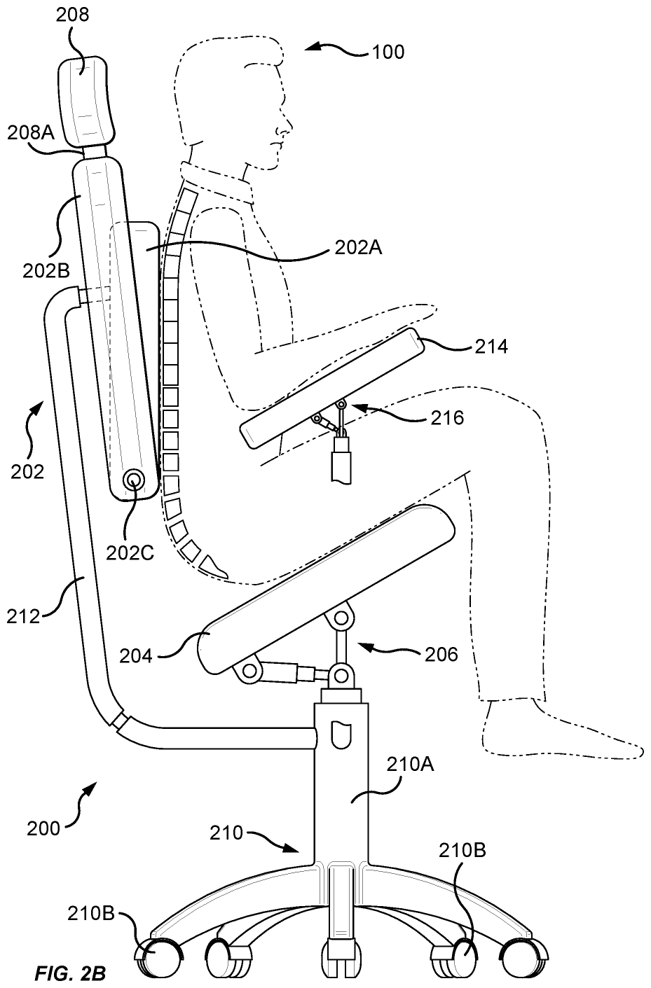

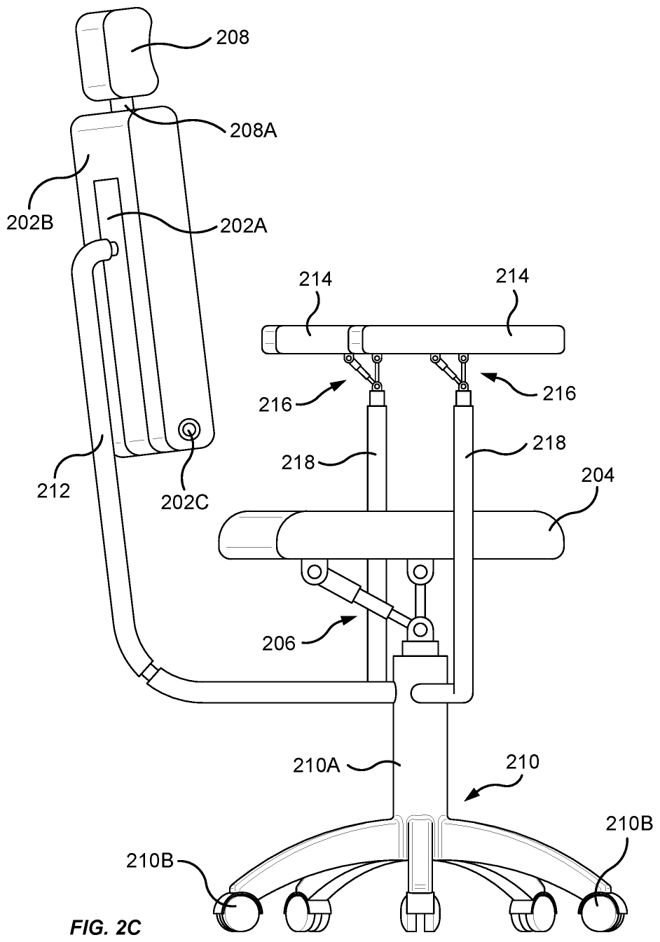

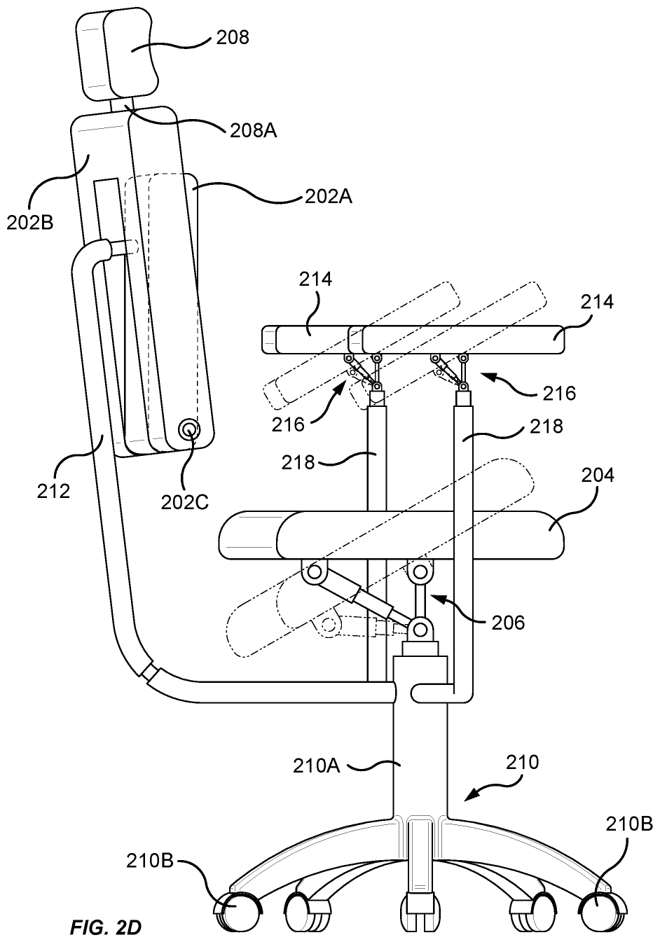

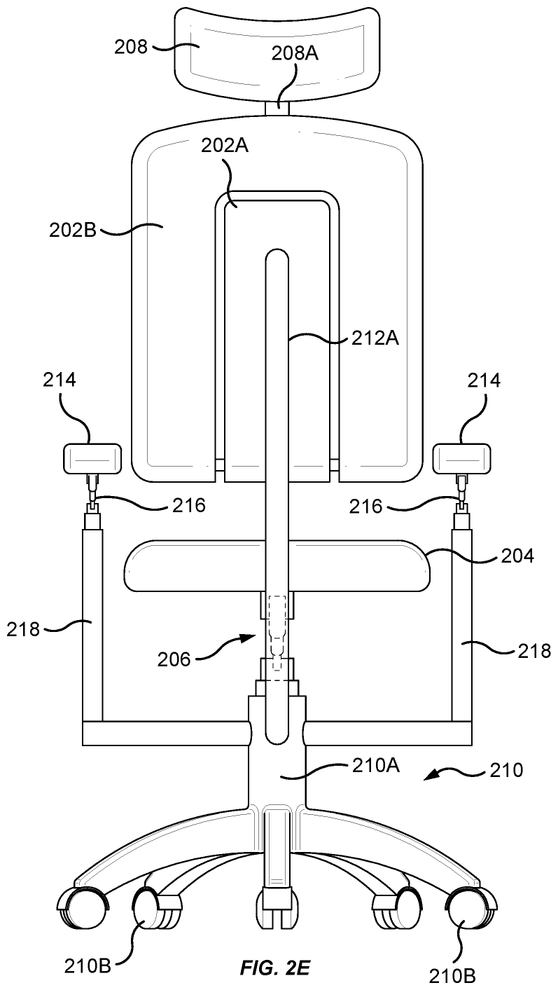

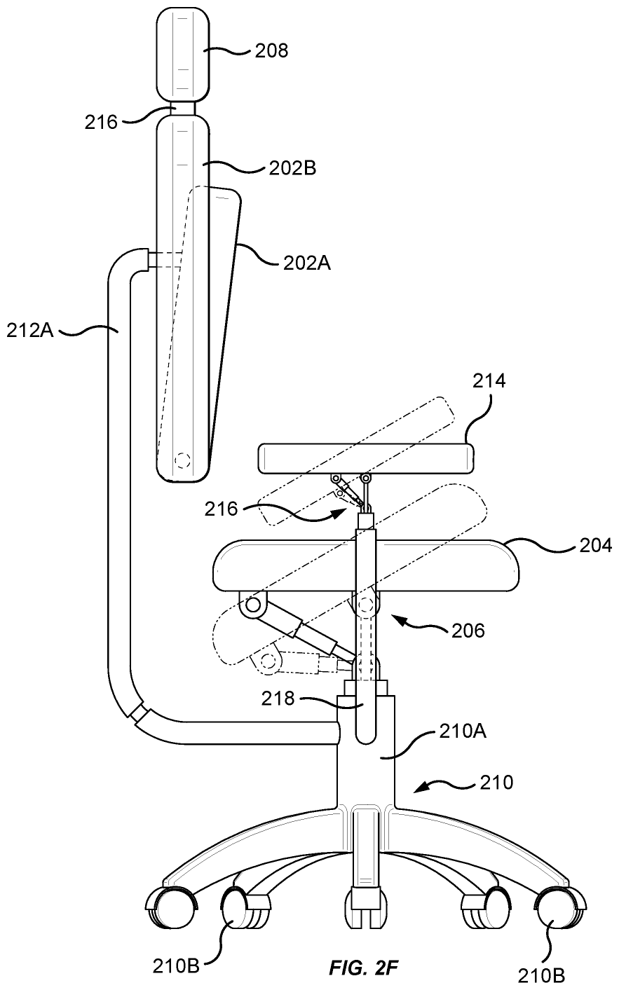

FIGS. 2A and 2B illustrate an occupant 100 seated in a reverse-tilt chair 200 according to an embodiment of the first aspect of the present disclosure. FIG. 2A illustrates a side view of the occupant 100 seated in the reverse-tilt chair 200 in a standard position of the reverse-tilt chair 200, while FIG. 2B illustrates a side view of the occupant 100 seated in the reverse-tilt chair 200 in a reverse tilted position of the reverse-tilt chair 200. As can be seen in FIGS. 2A and 2B, the occupant's spine is, in the reverse tilted position of the reverse-tilt chair 200, in a state of decompression as compared to the standard position. Specifically, the distance between individual vertebra in the lumbar region of the occupant's spine is greater in the reverse tilted position (illustrated in FIG. 2B) than in the standard position (illustrated in FIG. 2A). The reverse tilted position of the chair not only provides effective spinal decompression, but also mimics a squatting movement, also referred to as “Malasana”, which may also align the large intestine (colon) and promote evacuation of the bowels, removal of toxins from the body, and general restoration of good health. The reverse tilted seat also is configured to cause stretching and strengthening of the pelvic muscles (which can be especially beneficial for some women with pelvic dysfunctions) or even urinary dysfunctions caused by nerve compression and subsequent muscles contraction. With regular use, the chair (200) may be effective at preventing and even treating various forms of back pain and/or nerve compression.

FIGS. 2C and 2D illustrate perspective views of the reverse-tilt chair 200. FIG. 2C illustrates the reverse-tilt chair 200 in an unoccupied state and a standard position, while FIG. 2D illustrates the reverse-tilt chair 200 in an unoccupied state and both the standard position (in solid lines) and a reverse tilted position (in dotted lines). FIGS. 2E and 2F illustrate the reverse-tilt chair 200 in a rear view and a side view, respectively. FIG. 2F illustrates an exemplary reverse tilting action of the reverse-tilt chair.

The reverse-tilt chair 200 includes a back support 202, a seat pan 204, a seat tilting mechanism 206, an optional headrest 208, a base 210, a support structure 212 for the back support 202, armrests 214, armrest tilting mechanisms 216, and support structures 218 for armrests 214. As illustrated, the back support 202 and seat pan 204 (also known as the “seat assembly”) are configured as a conventional back support/seat pan, but in alternative embodiments can be configured as ergonomic back support/seat cushion assemblies that conform to a human sitting shape.

The back support 202 is connected to the base 210 via the support structure 212. The support structure 212 can be configured to allow the back support 202 to recline, e.g. via a relative motion between the support structure 212 and the base 210. The support structure 212 can be constructed so as to be resilient, allowing an occupant to apply pressure to the back support 202 to bring about a reclining of the back support 202 and returning to its initial position following the removal of said pressure. The back support 202 includes a center section 202A and a perimeter section 202B. The center section can be configured to extend towards the front of the reverse-tilt chair 200, or alternatively, the perimeter section 202B can be configured to recline relative to the center section 202A while the center section 202A remains stationary. When the occupant 100 is seated in the reverse-tilt chair 200 in a reverse tilted position, the relative motion between the center section 202A and the perimeter section 202B can provide support to the occupant's thorax and thereby provide traction to the spine that enhances spinal decompression. Specifically, the relative motion of the center section 202A and the perimeter section 202B promotes an upright position of the spine during the reverse-tilting of the seat pan 204 thereby providing traction to the spine. In order to facilitate the relative motion of the center section 202A and the perimeter section 202B, a combination of a rod and/or hinges can be provided. Optionally, the reverse-tilt chair 200 includes a headrest 208 configured to secure/support a human neck and/or head. In the embodiment of the reverse-tilt chair 200 depicted in FIGS. 2A through 2F, the headrest 208 is supported by a headrest support 208A that extends from the perimeter section 202B of the back support 202. In a standard position of the chair, the headrest 208 merely provides head and neck support. However, in the reverse-tilted position, the headrest 208 can be extended—either manually or hydraulically—to provide traction to the cervical region of the spine and thereby promote cervical decompression. Furthermore, as the spine is a single connected unit, providing cervical decompression can enhance the degree of thoracic and lumbar decompression brought about by the reverse-tilt chair 200.

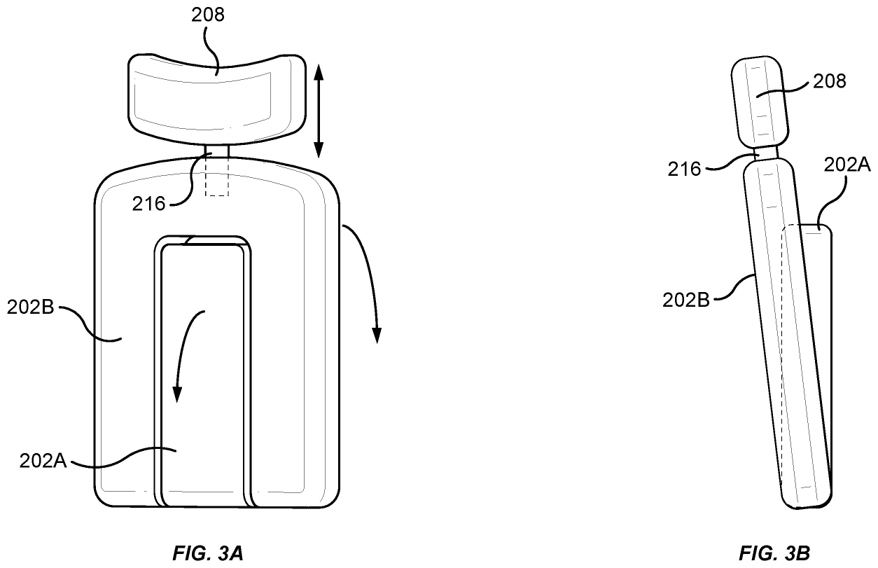

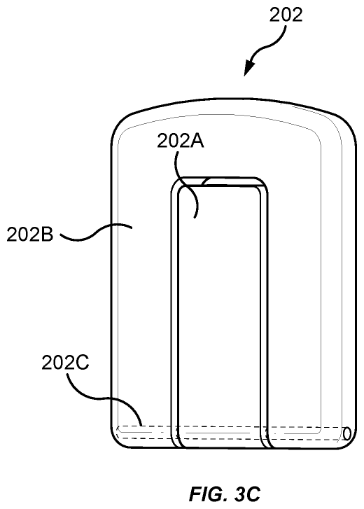

FIGS. 3A through 3C illustrate the back support 202 of the reverse-tilt chair 200 of FIG. 2. FIG. 3A illustrates a perspective view of the back support 202. The headrest 208 is configured to vertically extend and retract relative to the back support 202 via insertion and extraction of the headrest support 208A from a receptacle in the perimeter section 202B of the back support 202. FIG. 3B illustrates a side view of the back support 202. In FIG. 3B, the center section 202A of the back support 202 is moved relative to the perimeter section 202B so as to protrude in a forward direction. As a result of this movement, the center section 202A can provide additional support to the thorax of an occupant, thereby providing traction to the spine and enhancing spinal decompression. FIG. 3C illustrates a perspective view of the back support 202 in which a rod 202C extending through the interior of the bottom of the back support 202 can be seen. The rod 202C allows a relative rotational motion of the center section 202A and the perimeter section 202B. Said relative rotational motion enables the forward protrusion, illustrated in FIG. 3B, of the center section 202A from the perimeter section 202B.

The seat pan 204 is connected to the base 210 via the seat tilting mechanism 206. Activation of the seat tilting mechanism 206 results in a reverse-tilt, or declination, of the seat pan 204 to a reverse tilted seat position. In one variation of the embodiment of the reverse-tilt chair illustrated in FIGS. 2A through 2F, the tilting mechanism 206 is configured as a backward, synchro-tilt mechanism to enable a fixed ratio synchronous tilt movement. A ratcheting mechanism may be configured to incrementally move, limit, and/or lock a tilting action by a configured amount, until a release mechanism in the tilting mechanism 206 brings the seat pan 204 back to its default position, e.g. a horizontal position (as illustrated, e.g., in FIGS. 2A, 2C). The tilting mechanism 206 may be configured with one or more pneumatic and/or spring-loaded piston mechanisms that effectuate a reverse-tilt, or declination, adjustment of the seat pan 204 downward in a configured path to facilitate spinal decompression. It will be understood by those skilled in the art that, while the tilting mechanism 206 is illustrated in FIGS. 2A through 2F as having a particular combination of pivot joints and a depressible piston, the tilting mechanism 206 can be provided in the form of any combination of joints and mechanisms that synchronously operate to effectuate a reverse-tilt, or declination, adjustment that applies spinal decompression to a patient.

The armrests 214 are connected to the base 210 via the armrest tilting mechanisms 216 and the support structures 218. The armrest tilting mechanisms 216 can be configured in the same manner as the seat tilting mechanism 206. Therefore, the armrest tilting mechanisms 216 can be configured as backward, synchro-tilt mechanisms that enable a fixed ratio synchronous tilt movement. A ratcheting mechanism may be configured to incrementally move, limit, and/or lock a tilting action by a configured amount, until a release mechanism in the tilting mechanisms 216 bring the armrests 214 to their default position, e.g. a horizontal position (as illustrated, e.g., in FIGS. 2A, 2C). While the tilting mechanisms 216 illustrated in FIGS. 2A through 2F have a particular combination of pivot joints and a depressible piston, the tilting mechanisms 216 can be provided in the form of any combination of joints and mechanisms that synchronously operate to effectuate a reverse-tilt, or declination, adjustment of the armrests 214. In various embodiments of the reverse-tilt chair, the armrest tilting mechanisms 216 can be synchronized with the seat tilting mechanism 206. For example, a controller can be provided that is configured to actuate the seat tilting mechanism 206 and the armrest tilting mechanisms 216 in a synchronous manner.

While only two positions of the seat pan 204 and the armrests 214 are illustrated in FIGS. 2D and 2F, the declination of the seat pan 204 and the armrests 214 can be effectuated along a multitude of preconfigured positions (e.g., 10-20 positions) or continuously from a horizontal position to a position of maximum declination. For example, a predetermined declination increment may be provided (one degree, two degrees, five degrees, ten degrees, fifteen degrees, etc.), and the full range of declination of the seat pan 204 and the armrests 214 would be broken down to a preconfigured number of positions. For example, using a fixed adjustment increment of three degrees of declination, the seat pan 204 of the chair 200 may be configured with twenty positions, resulting in a total range of declination of sixty degrees. According to various embodiments, a ratchet assembly in the tilting mechanism 206 could lock each increment prior to proceeding to the next increment. Notably, the chair 200 is configured to provide declination of the seat pan 204 independently from any movement of the back support 202.

By providing a range of possible declination positions of the seat pan 204, the chair 200 can be adjusted by an occupant to safely apply a desired degree of spinal decompression and to safely target specific regions of the spine. In other words, the amount and target location of spinal decompression may be adjusted by modifying the degree of the reverse-tilt, or declination, of the seat pan 204. Larger amounts of declination would create greater separation of the spinal segments and target vertebrae in a progressively cranial direction, while lower amounts of declination would create lesser separation of the spinal segments and target only vertebrae in the lumbar region of the spine. For example, a seat pan declination of 25 degrees would engage the L5-S1 vertebrae, while a seat pan declination of 35 degrees would engage the L3-L4 vertebrae with greater separation between segments and greater reduction of pressure on the peripheral nerves exiting the intervertebral foramen, thereby promoting greater pain relief.

In variations of the reverse-tilt chair 200, the seat tilting mechanism 206 is configured to move the seat pan 204 to a plurality of different declination positions, each respective declination position being configured to target a different region of the spine for decompression. For example, the tilting mechanism 206 can be configured to move the seat pan 204 to a first declination position configured to target the lumbar region of the spine for decompression and to move the seat pan 204 to a second declination position configured to additionally target the thoracic region of the spine for decompression. Alternatively or additionally, the tilting mechanism 206 can be configured to move the seat pan 204 to a plurality of different declination regions, each respective declination region being configured to target a different region of the spine for decompression. Each respective declination region can include a plurality of declination positions, each respective declination position being configured to target one or multiple specific vertebrae for decompression. For example, the tilting mechanism 206 can be configured to move the seat pan 204 to a plurality of different declination positions within a first declination region, the plurality of different declination positions within the first declination region including a first position configured to target the sacrum and L5 vertebra for decompression, a second position configured to target the L4 and L3 vertebrae for decompression, and a third position configured to target the L2 and L1 vertebrae for decompression. While different declination positions may target specific vertebrae for decompression, each respective declination position may simultaneously promote decompression of additional vertebrae that are not specifically targeted by the respective declination position.

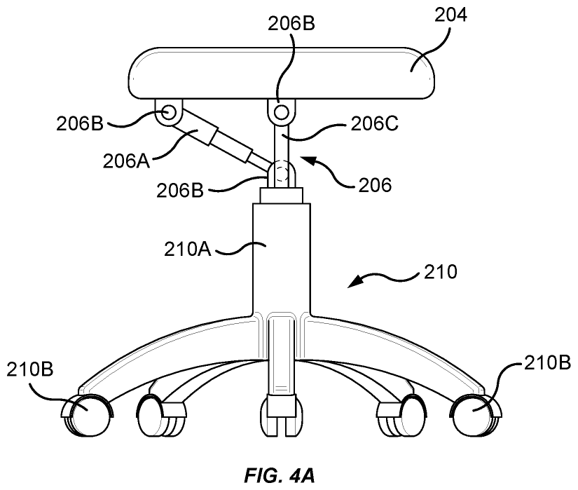

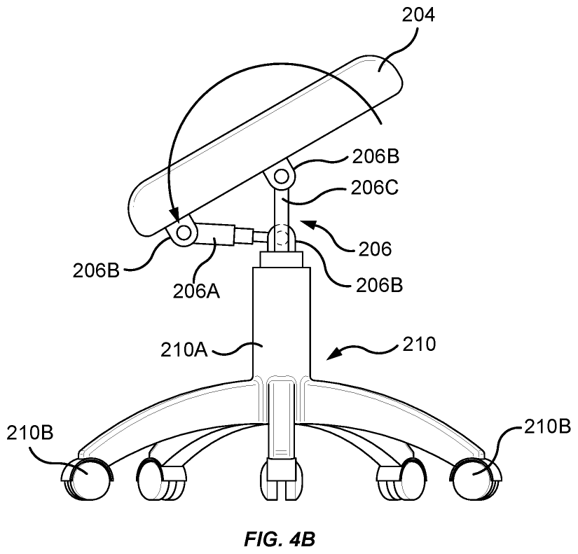

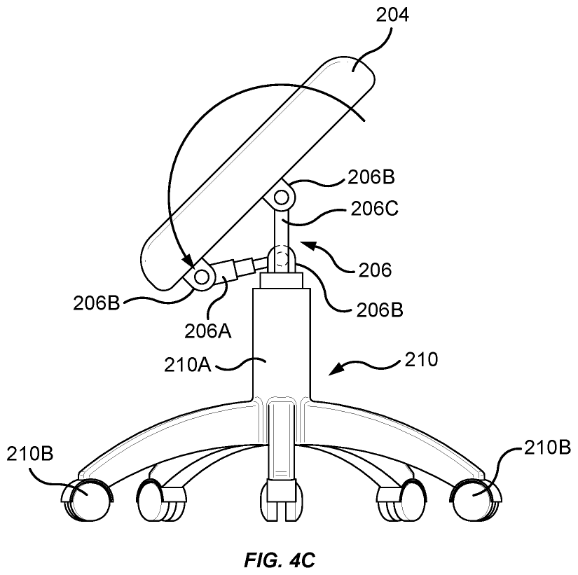

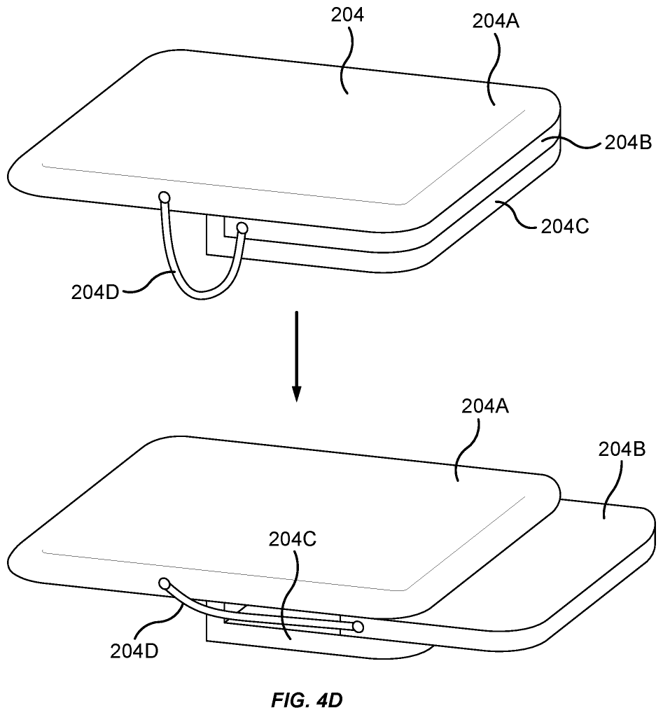

FIGS. 4A through 4C illustrate the seat pan 204 and the seat tilting mechanism 206 in three different positions—i.e. a standard horizontal position (FIG. 4A), a first reverse tilted position (i.e. first declination position) corresponding to an approximately 45° decline (FIG. 4B), and a second reverse tilted position (i.e. second declination position) corresponding to an approximately 60° decline (FIG. 4C). The seat tilting mechanism 206 illustrated in FIGS. 4A through 4C includes a piston 206A, a number of pivot joints 206B, and a support column 206C that connects the main column 210A of the base 210 with the seat pan 204. FIG. 4D illustrates an optional seat pan extension mechanism. In FIG. 4D, the seat pan 204 includes a retractable extension piece 204B configured to slide towards the front of the reverse-tilt chair 200 from between a top portion 204A and a bottom portion 204C. Also in FIG. 4D, an optional strap 204D connects the retractable extension piece 204B to the top portion 204A of the seat pan 204. Such a seat pan extension mechanism provides an adjustment by which the seat pan 204 of the chair can be adapted to better fit different occupants of different sizes. For example, the seat pan can be extended to better fit an occupant with legs longer than the mean leg length for a human.

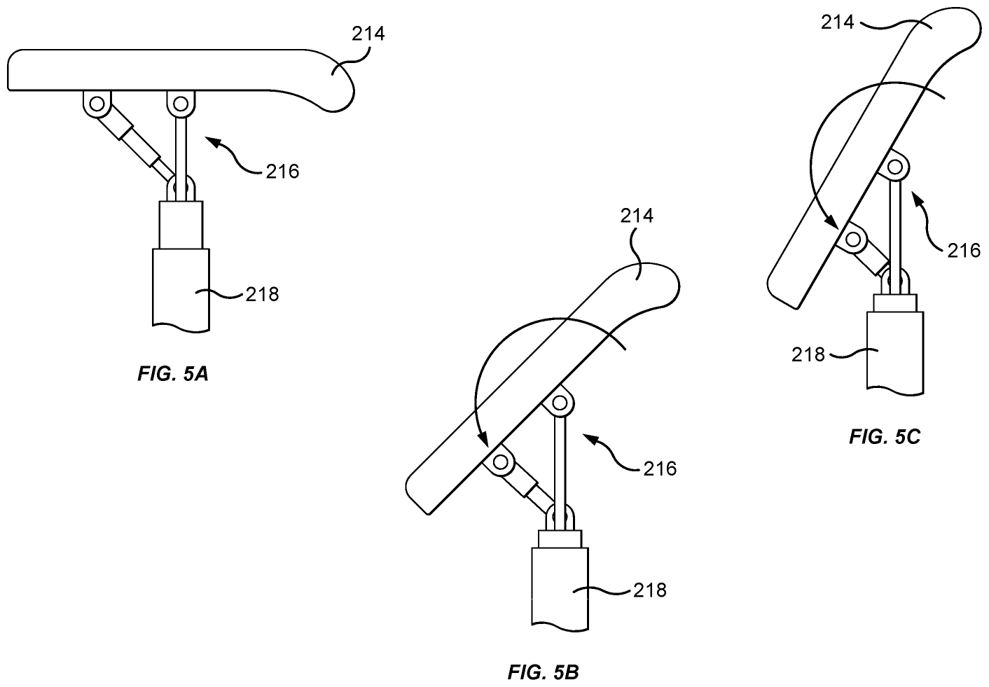

FIGS. 5A through 5C illustrate an armrest 214 and an armrest tilting mechanism 216 in three different positions—i.e. a standard horizontal position (FIG. 5A), a first reverse tilted position (i.e. first declination position) corresponding to an approximately 45° decline (FIG. 5B), and a second reverse tilted position (i.e. second declination position) corresponding to an approximately 60° decline (FIG. 5C).

In order to address and maximize decompression of the thoracic spine, the present disclosure combines a lumbar spine seat reverse tilt function (e.g., via the seat tilting mechanism 206 and the seat pan 204) with a graduated traction feature (e.g., via the back support 204). In the case of the chair 200, the graduated traction feature can be provided by the center section 202A, which ensures the spine remains in an upright position (as opposed to a reclined position) thereby enhancing the effectiveness of the spinal decompression achieved by declination of the seat pan 204.

In variations of the reverse-tilt chair 200, the seat tilting mechanism 206 and the armrest tilting mechanisms 216 can be locked, or disabled, in a standard mode. In the standard mode, movement of the back support 202 and the seat pan 204 is synchronized. Synchronized movement of the back support 202 and the seat pan 204 can be achieved by providing a further, conventional tilting mechanism—e.g. a conventional tilting mechanism integrated into the base 210. The conventional tilting mechanism can be configured such that an inclination of the back rest 204 results in a proportional declination of the seat assembly 204. For example, the further, conventional tilting mechanism may be configured with a 2:1 ratio, such that the seat assembly 204 declines one degree for each two-degree inclination in the back support 202. Other ratios are also contemplated. The further, conventional tilting mechanism may be configured with knee tilt mechanisms such that the seat declination is off-center, and closer to the front of the seat, facing away from the back support, in order to minimize the chance of a user's feet being forced to lift off the ground. In one example, the base 210 may also include a seat lowering mechanism, which lowers the seating plane of the seat pan 204. The seat lowering mechanism may particularly be advantageous in applications where the seat assembly 204 declination is configured as substantially center-tilt.

The base 210 includes a main column 210A and a plurality of arms that each terminate in a chair wheel 210B (to enable the reverse-tilt chair to roll on the floor). It will be understood by those skilled in the art that, while the base 210 is illustrated in FIGS. 2A through 2F as having a particular geometry, the base 210 can be provided in a variety of different forms capable of supporting the seat assembly and the various support structures and housing the combination of joints and mechanisms that enable the functionality described above, e.g. allowing the back support 202 to recline (e.g. in a standard mode).

The reverse-tilt chair 200 eliminates the need for a secondary operator and can be operated by the individual to alleviate pain in the convenience of one's home or sitting long hours behind the desk in the office. By utilizing vertical traction, the decompression action causes the spinal vertebrae segments and the discs between each spinal segment to move apart (more distance between them) which subsequently creates more space in intervertebral Foramen where the peripheral nerves exit the spinal column and release the nerve and relieve the pain.

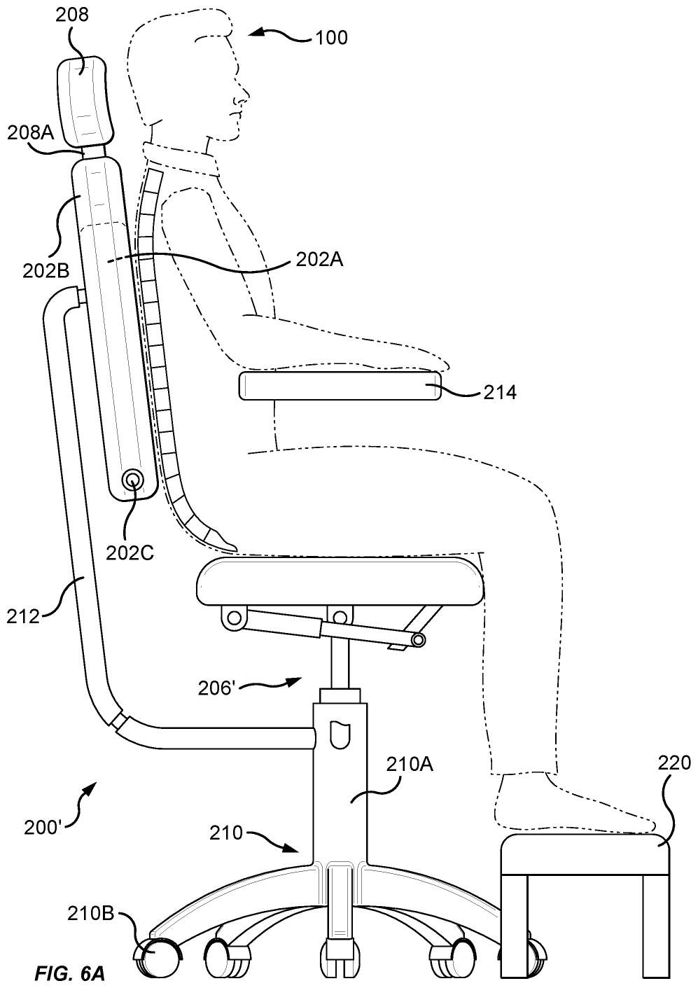

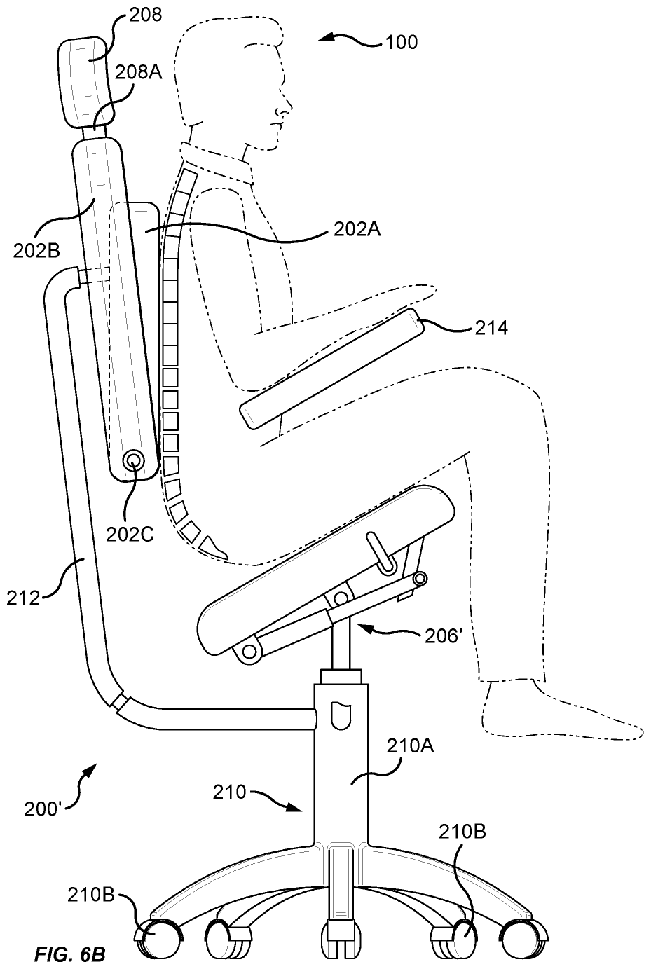

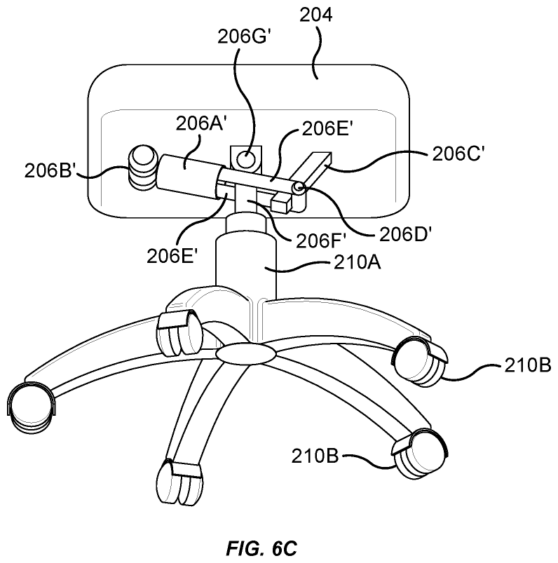

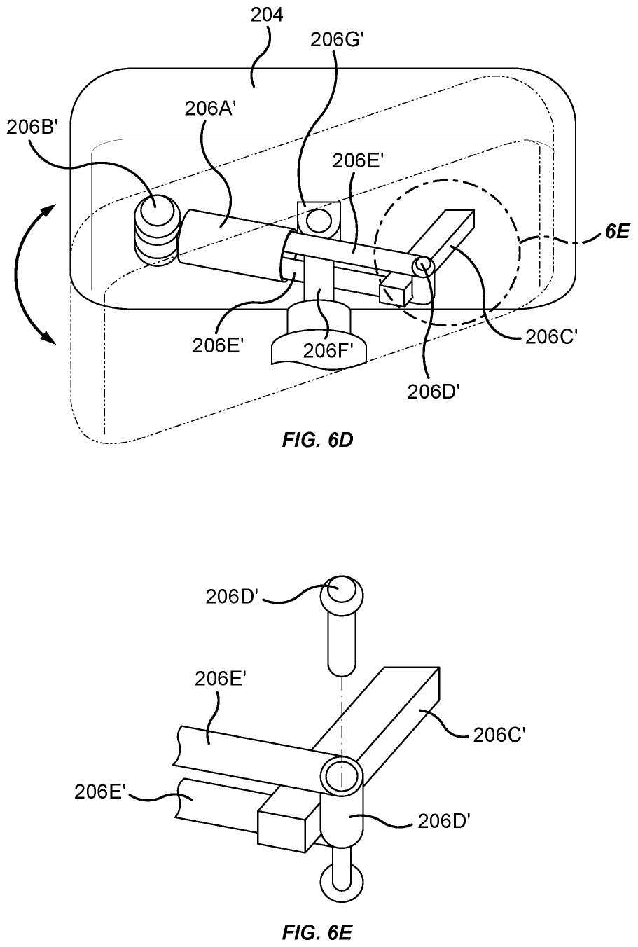

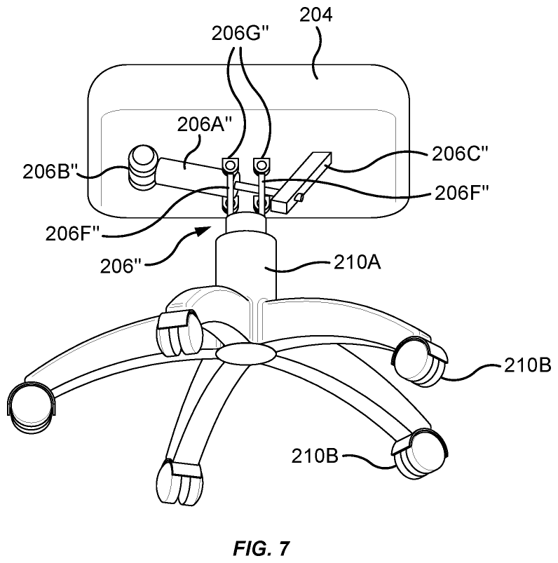

FIGS. 6A through 6E illustrate an alternative embodiment of the reverse-tilt chair 200′ with an alternative seat tilting mechanism 206′ having a different combination of pivot joints and a depressible piston than the tilting mechanism 206 illustrated in FIGS. 2A through 2F and 4A through 4C. FIGS. 6A and 6B illustrate an occupant 100 seated in the reverse-tilt chair 200 with an alternative tilting mechanism 206′. FIG. 2A illustrates a side view of the occupant 100 seated in the reverse-tilt chair 200 in a standard position of the reverse-tilt chair 200, while FIG. 2B illustrates a side view of the occupant 100 seated in the reverse-tilt chair 200 in a reverse tilted position of the reverse-tilt chair 200. FIG. 6C illustrates the alternative tilting mechanism 206′ and the base 210 of the reverse-tilt chair 200 illustrated in FIGS. 6A and 6B, while FIGS. 6D and 6E provide close-up illustrations of the alternative tilting mechanism 206′. The alternative tilting mechanism 206′ includes a piston 206A′, a first pivot joint 206B′, a fixed support 206C′, a second pivot joint 206D′, and support rails 206E′. The alternative tilting mechanism 206′ also includes a support column 206F′, which connects the main column 210A of the base 210 to the bottom of the seat pan 204 via a third pivot joint 206G′. FIG. 7 illustrates a perspective view of a base 210 and a seat pan connected to the base 210 via a further alternative tilting mechanism 206″. In the further alternative tilting mechanism 206″, multiple support columns 206F″ are provided, each of which connects the main column 210A of the base 210 to the bottom of the seat pan 204 via a respective third pivot joint 206G″.

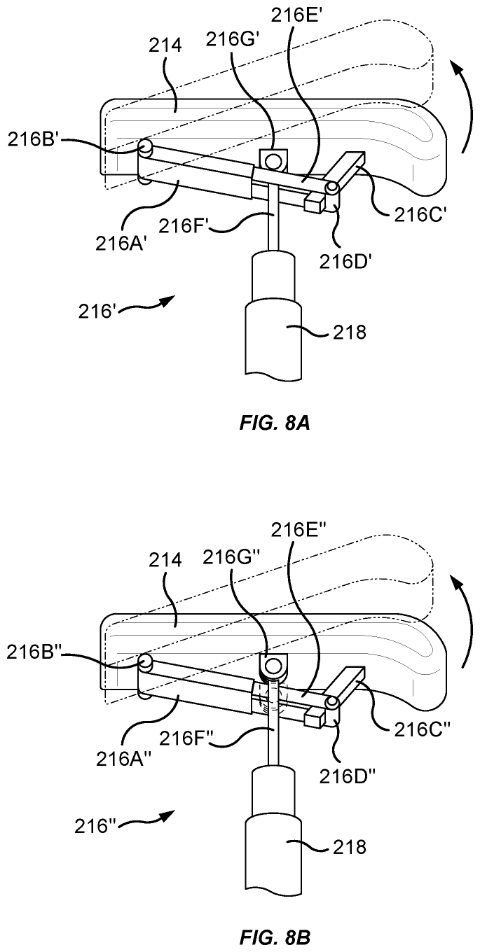

FIGS. 8A and 8B illustrate alternative armrest tilting mechanisms 216′ and 216″—both of which have a different combination of pivot joints and a depressible piston than the armrest tilting mechanism 216 illustrated in FIGS. 2A through 2F and 5A through 5C.

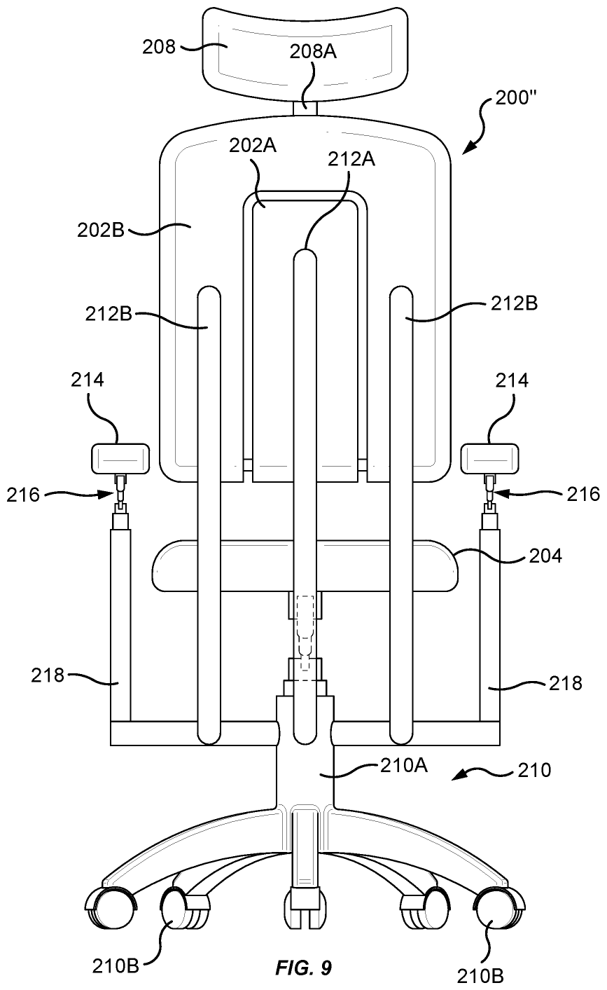

FIG. 9 illustrates an alternative embodiment of the reverse-tilt chair 200″ with additional support structures for the back support 202. In the embodiment of the reverse-tilt chair 200″ illustrated in FIG. 9, a first support structure 212A is provided for the center section 202A, and a second support structure 212B, which includes two support arms, is provided for the perimeter section 202B.

In any embodiment of the reverse-tilt chair 200, a separate foot rest 220 (as illustrated, e.g. in FIG. 2A) may be provided to facilitate improved spinal traction and comfort.

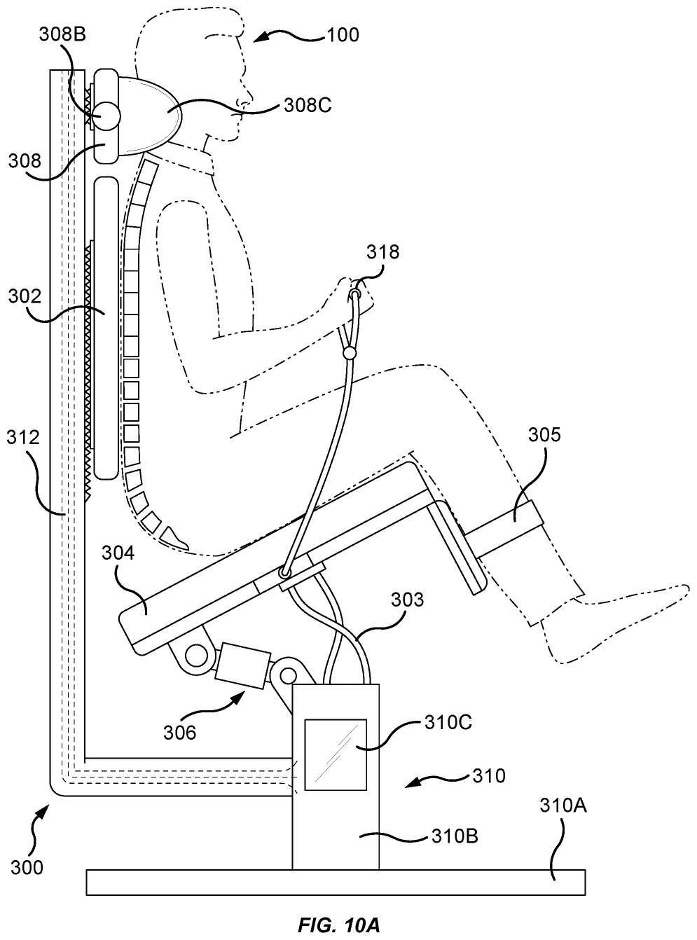

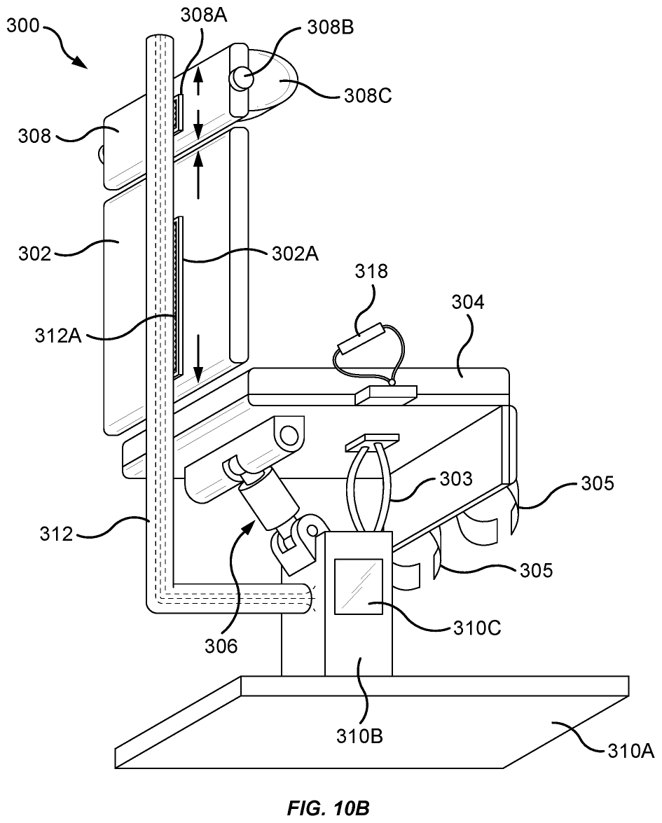

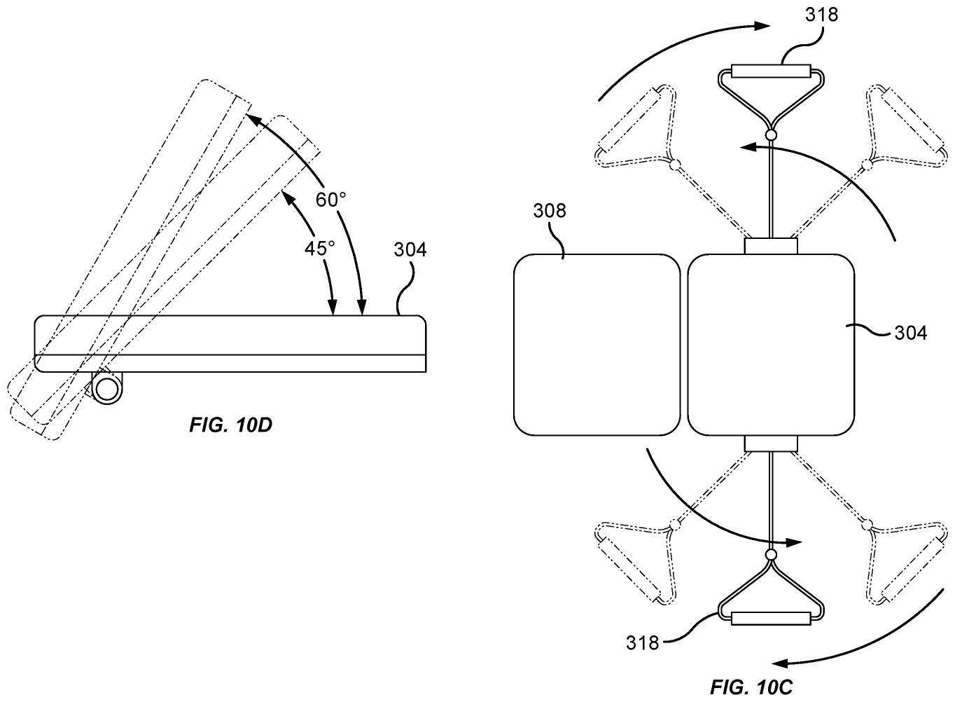

FIGS. 10A through 10D illustrate a clinical medical rehabilitation/physical therapy device according to an embodiment of the second aspect of the present disclosure. The clinical medical rehabilitation/physical therapy device 300 is configured to facilitate spinal decompression treatment of a patient situated in a seated position.

FIG. 10A illustrates a side view of an occupant 100 seated in the clinical medical rehabilitation/physical therapy device 300. The occupant's spine is in a state of decompression facilitated by the clinical medical rehabilitation/physical therapy device 300. Specifically, the distance between individual vertebra in the lumbar region of the occupant's spine is increased relative to a standard seating position as a result of the action of the clinical medical rehabilitation/physical therapy device 300, which not only provides effective spinal decompression, but also mimics a squatting movement, also referred to as “Malasana,” which promotes a number of benefits discussed in connection with FIG. 2B above.

FIG. 10B illustrates a perspective view of the clinical medical rehabilitation/physical therapy device 300. The device 300 includes a back support 302, a seat pan 304, a seat tilting mechanism 306, a headrest 308, a base 310, and a support structure 312 for the back support 302 and the headrest 308. The support structure 312 includes a plurality of teeth configured to mate with corresponding teeth of the back support 302 and corresponding teeth of the headrest 308 to enable the back support 302 and the headrest 308 to move in a vertical direction along the support structure 312. In this manner, both the back support 302 and the headrest 308 can be adjusted to an occupant. The headrest 308 includes cervical traction supports 308C that are configured to provide support to the cervical region of an occupant's spine and thereby provide traction to promote further decompression of the occupant's spine. Specifically, the cervical traction supports 308C stabilize the cervical vertebra of the occupant's spine in a desired position and in an upright orientation to enhance spinal decompression, particularly in the cervical region of the spine.

The seat pan 304 is connected to the base 310 via the seat tilting mechanism 306. Furthermore, cables 303 provide a pathway to communicate electrical signals from the base 310, e.g. signals for control of the position of the seat pan 304. Activation of the seat tilting mechanism 306 results in a reverse-tilt, or declination, of the seat pan 304 to a reverse tilted seat position. As in the seat tilting mechanism 206 of the reverse-tilt chair 200, a ratcheting mechanism may be configured to incrementally move, limit, and/or lock a tilting action of the seat tilting mechanism 306 by a configured amount, until a release mechanism brings the seat tilting mechanism 306 back to its default position, e.g. a horizontal position (as illustrated, e.g., in FIG. 10B). The tilting mechanism 306 may be configured with one or more pneumatic and/or hydraulic piston mechanisms that effectuate a reverse-tilt, or declination, adjustment of the seat pan 304 downward in a configured path to facilitate spinal decompression. It will be understood by those skilled in the art that, while the tilting mechanism 306 is illustrated in FIGS. 10A and 10B as having a particular combination of pivot joints and a piston, the tilting mechanism 306 can be provided in the form of any combination of joints and mechanisms that operate to effectuate a reverse-tilt, or declination, adjustment that applies spinal decompression to a patient. In order to enhance spinal decompression, the seat pan 304 includes a vertically-extending section to which straps 305 are attached. The straps 305 are configured to attached to an occupant between the occupant's knees and ankles and thereby provide enhanced attachment of the occupant to the device 300. As a result of the enhanced attachment, slipping and sliding of the occupant within the device can be reduced, and spinal decompression accordingly enhanced.

The declination of the seat pan 304 can be effectuated along a multitude of preconfigured positions (e.g., 10-20 positions) or continuously from a horizontal position to a position of maximum declination. For example, a predetermined declination increment may be provided (one degree, two degrees, five degrees, ten degrees, fifteen degrees, etc.), and the full range of declination of the seat pan 304 would be broken down to a preconfigured number of positions. For example, using a fixed adjustment increment of three degrees of declination, the seat pan 304 may be configured with twenty positions, resulting in a total range of declination of sixty degrees. According to various embodiments, a ratchet assembly in the tilting mechanism 306 could lock each increment prior to proceeding to the next increment. By providing a range of possible declination positions of the seat pan 304, the clinical medical rehabilitation/physical therapy device 300 can be adjusted by a clinician to safely apply a desired degree of spinal decompression and to safely target specific regions of the spine. In other words, the amount and target location of spinal decompression may be adjusted by modifying the degree of the reverse-tilt, or declination, of the seat pan 304. Larger amounts of declination would create greater separation of the spinal segments and target vertebrae in a progressively cranial direction, while lower amounts of declination would create lesser separation of the spinal segments and target only vertebrae in the lumbar region of the spine. For example, a seat pan declination of 25 degrees would engage the L5-S1 vertebrae, while a seat pan declination of 35 degrees would engage the L3-L4 vertebrae with greater separation between segments and greater reduction of pressure on the peripheral nerves exiting the intervertebral foramen, thereby promoting greater pain relief.

In variations of the clinical medical rehabilitation/physical therapy device 300, the seat tilting mechanism 306 is configured to move the seat pan 304 to a plurality of different declination positions, each respective declination position being configured to target a different region of the spine for decompression. For example, the tilting mechanism 306 can be configured to move the seat pan 304 to a first declination position configured to target the lumbar region of the spine for decompression and to move the seat pan 304 to a second declination position configured to target the thoracic region of the spine for decompression. Alternatively or additionally, the tilting mechanism 306 can be configured to move the seat pan 304 to a plurality of different declination regions, each respective declination region being configured to target a different region of the spine for decompression. Each respective declination region can include a plurality of declination positions, each respective declination position being configured to target one or multiple specific vertebrae for decompression. While different declination positions may target specific vertebrae for decompression, each respective declination position may simultaneously promote decompression of additional vertebrae that are not specifically targeted by the respective declination position.

The arm-pulleys 318 create even more intense freedom and release of the compressed spine vertebrae which often can be restricted by lumbar and thoracic para-spinal musculatures. The arm pulleys enable an occupant of clinical medical rehabilitation/physical therapy device 300 to increase spinal traction while the seat pan 304 is positioned in a declined position.

FIG. 10C illustrates an example of arm pulley movements, as the pulleys can be moved both forwards and backwards by an occupant of the device 300. The pulleys may be configured to facilitate mobilization and release the paraspinal muscles that consequently will facilitate spinal movements and decompression. During use, an occupant of the chair 300 may hold each of the handles 318 with a respective hand and extend both handles towards the front direction of the chair as shown to further enhance leverage and thus spinal decompression during use. Pulley cables 318 may be configured as elastic cables, where the elasticity of each cable is configured to give a user greater leverage. In some examples, the pulley cables 318 may be configured as rigid cables respectively coupled to a gear configuration in each respective pulley assembly, wherein the forward leverage would be determined from a gear ratio relative to the chair movement. In some examples, the gear ratio may be tied to seat assembly 304 via ratios of a gear assembly associated with the tilting mechanism 306, such that the pulley handles 318 may be extended synchronously with the remainder of the device 300. For example, using a 1:3 ratio, the seat pan 304 would be configured to decline one increment, and each of the pulley cables 318 would be configured to move three increments, and thus extend handles a commensurate distance.

The base of the clinical medical rehabilitation/physical therapy device 300 includes a touch-screen display 310C via which a clinician can provide input to the device 300. Such input can be used, e.g., to set an amount of declination of the seat pan 304 or a position of the back support 302 and headrest 308 on the support structure 312. Alternatively, the touch-screen display 310C can be provided on a remote control device, such as a smartphone, to enable the clinician to control device 300 remotely.

Various aspects of the present disclosure illustrate a practical self-operated therapeutic vertical spinal decompression equipment unit or chair that may be utilized in an office or rehab/medical facilities for both remedy and to prevent low back pain, mid back pain and even neck pain. This is accomplished using the reverse backward seat tilt movement disclosed herein that facilitates in creating the spinal segment(s) to open up and provide relief. The configurations provide a unique vertical spinal decompression equipment/chair that creates decompression effects by an adjustable reverse seat tilt function. With additional pulley cables on either side, when used in combination with the adjustable tilted seat, the configuration creates even more intense freedom and release of the compressed spine vertebrae which often can be restricted by lumbar and thoracic para-spinal musculatures. The disclosed configurations further create vertical traction/decompression of the area of the thoracic spine by creating a graduated decompression action which causes the vertebras/discs between each spinal segment to move apart (more distance between them) and would create more space in IVF (intervertebral foramen) where the peripheral nerves exit the spinal column.

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In the foregoing detailed description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

What is claimed is:

1. A therapeutic chair, comprising:
a back support;
a seat pan; and
a seat pan tilting mechanism coupled to the seat pan, the seat pan tilting mechanism configured to decline the seat pan from a standard position to a selected declined seat pan position, the selected declined seat position being selected from one of a plurality of declined positions, wherein each of the plurality of declined positions corresponds to an angle of declination of the seat pan,
wherein the seat pan tilting mechanism is configured to decline the seat pan to the selected declined seat pan position independent from a reclining motion of the back support.

2. The therapeutic chair of claim 1, further comprising a base, wherein the back support is connected to the base via a first structure and the seat pan is connected to the base via a second structure independent from the first structure.

3. The therapeutic chair of claim 2, wherein the seat pan tilting mechanism is a component of the second structure.

4. The therapeutic chair of claim 1, wherein the seat pan tilting mechanism comprises a pivot joint and a depressible piston.

5. The therapeutic chair of claim 1, wherein the seat pan tilting mechanism is configured to lower a rear portion of the seat pan relative to a front portion of the seat pan, the rear portion of the seat pan disposed proximal to the back support and the front portion of the seat pan disposed distal from the back support.

6. The therapeutic chair of claim 1, wherein the plurality of declined positions are configured such that each respective declined position targets a respective target region of a spine of the occupant for decompression.

7. The therapeutic chair of claim 6, wherein the respective target region of the human spine is selected from the group consisting of: a lumbar region, a thoracic region, and a cervical region.

8. The therapeutic chair of claim 1, wherein each respective declined position of the plurality of declined positions is further configured to target one or more respective vertebrae for spinal decompression.

9. The therapeutic chair of claim 1, further comprising a traction assembly configured to support a thorax of the occupant when the seat pan is declined position.

10. The therapeutic chair of claim 1, wherein the standard position corresponds to a minimum declination of the seat pan, and
wherein the maximum declination of the seat pan is an angle in a range of 45° to 60°, wherein the angle is measured between a first direction extending from a rear of the seat pan to a front of the seat pan and a horizontal direction that extends parallel to a floor on which the chair is configured to sit.

11. A physical therapy device configured to facilitate spinal decompression treatment of a patient situated in a seated position, the physical therapy device comprising:
a seat pan;
a tilting mechanism coupled to the seat pan, the tilting mechanism configured to decline the seat pan from a standard position to a selected declined seat pan position, the selected declined seat position being selected from one of a plurality of declined positions, wherein each of the plurality of declined positions corresponds to an angle of declination of the seat pan;
a back support; and
cervical traction supports;
wherein the seat pan tilting mechanism is configured to decline the seat pan to the selected declined seat pan position independent from a reclining motion of the back support.

12. The physical therapy device of claim 11, wherein the plurality of declined positions are configured such that each respective declined position targets a respective target region of a spine of the occupant for decompression.

13. The physical therapy device of claim 11, further comprising a retractable traction assembly, wherein the back support and the cervical traction supports are mounted on the retractable traction assembly and configured to move along the retractable traction assembly.

14. The physical therapy device of claim 11, further comprising two arm-pulleys positioned on either lateral side of the seat pan, wherein the arm-pulleys are configured to be pulled by the occupant to enhance spinal traction mobilization.

15. The therapeutic chair of claim 11, wherein a non-retracted length of the arm-pulleys is determined based on the selected seat pan position.
